(19) United States
(12) Patent Application Publication
(10) Pub. No.: US 2001/0033301 A1
(43) Pub. Date: Oct. 25, 2001

(54) Method and system for efficient and uniform formatting of selectable elements on a graphical user interface

(76) Inventor: Tony Hong, Diamond Bar, CA (US)

Correspondence Address: Tony Hong, 1548 Silver Lane, Diamond Bar, CA, 91765, US

(21) Appl. No.: 09/778,983

(22) Filed: Feb. 7, 2001

Related U.S. Application Data
(60) Provisional application No. 60/179,917, filed on Feb. 3, 2000.

(51) Int. Cl. G06F 3/14

(52) U.S. Cl. 345/810; 345/853

(57) ABSTRACT

This invention generally relates to web browsing, and more particularly to methods that generate and present uniform formats, which display contents of the web.

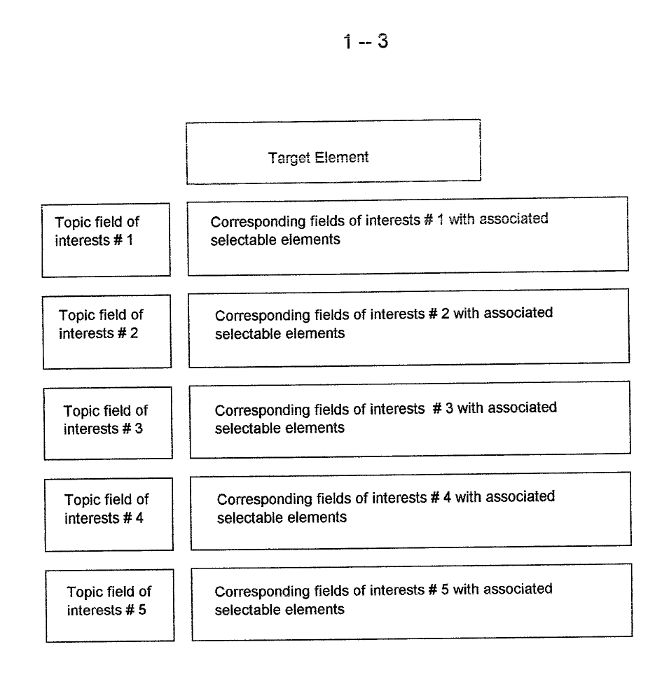

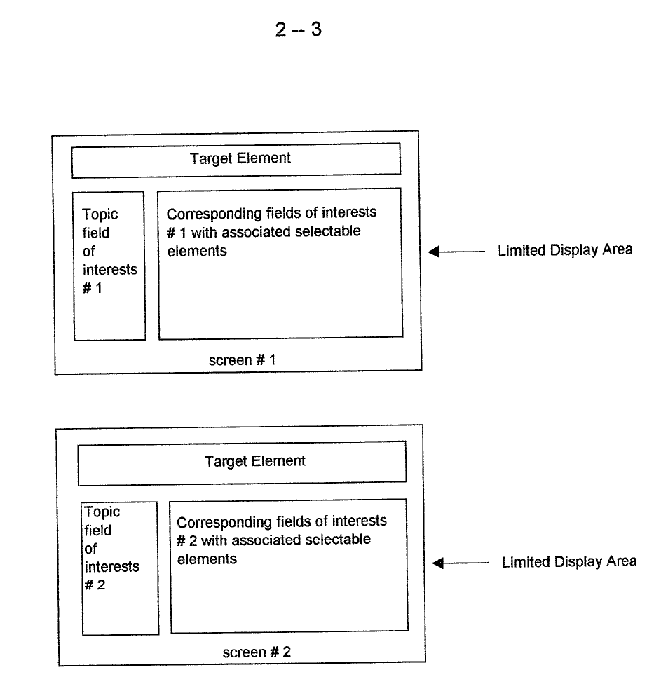

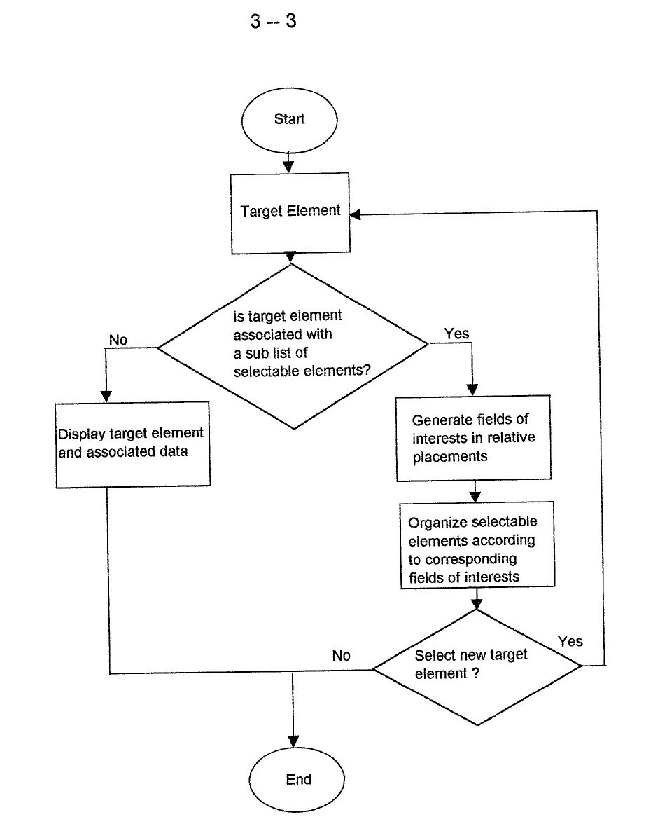

### BACKGROUND OF INVENTION

There is a variety of data and information available on the Internet, specifically the World Wide Web. As the contents of the web grow, however, current method of data searching and browsing became increasing inadequate for presenting the full range of relevant information while minimize the searching and browsing process. Current popular methods include directories and search engines. A directory usually presents contents, such as topic selections, in alphabetical order and lists. This static arrangement of data is inefficient in which a user is required to browse the entire topic selections without the guarantee of an optimal selection. This process often requires a user to check numerous topic selections in an inquiry. A search engine is also inefficient in pinpoint an optimal selection during an inquiry. Often the search method misinterprets the relevancy of the field of inquiry, and therefore returns result selections that are misleading and irrelevant to inquiry. Furthermore, current methods of searching and browsing varied in individual formats and display of data, that might be confusing and time consuming for users to learn and adopt the particular search methods.

A better method of searching and browsing the contents of the web would be to efficiently organize and distribute the contents in relevant and uniform fields of interest. A uniform format which presents intuit browsing experience that's quickly assessable while displaying the full range of relevant contents available on the web.

### SUMMARY OF INVENTION

The present invention includes a method of formatting and displaying a uniform collection of web contents. The method consists of designated topics as fixed fields of interest. Each field of interest serves to interact with a user inquiry. While each field represents an area of specialties, combination of all fields presents fullest coverage of contents on the web. The fields are limited to twenty specific categories, or forty topics, for concise representation of all interests. Categories can be further grouped into fields of interests, in which limited the numbers of field of interests, but which add up to full coverage of relevant contents. This will minimize the browsing process as users can quickly access an area of interests in a particular field, while ignoring other fields, even as full coverage of contents is presented in a page. Furthermore, fields of interests are arranged in relative positioning on the display as for optimal user recognition and browsing experience.

The method of this present invention involves the interaction between the fields of interests with the topic of inquiry, which in turns format and display associated subtopics in corresponding fields. Each selectable sub topics, in turn, act as the new topics of inquiry that corresponds in respect to the designated fields of interests.

This method can further be applied to any forms of display, including television, monitors, and mobile screens. Since each field of interests is formatted to cover a designated range of subjects, it can be displayed independently from each other. That is, on displays, which cannot accommodate the contents of all or some of the fields in one screen, an individual field is presented alone instead. Every field is relatively aligned vertically so it can be easily accessed by its relative location, and contents in each field are aligned horizontally for quick read. This is advantageous when browsing and selecting web contents can be easily accommodated by simple directional input value.

I claim:

1. A computer controlled method of providing a uniform formatted graphical user interface displaying selectable contents, said computer controlled method comprising the steps of:
receiving a target topic inquiry and displaying said target topic inquiry in a first element of graphical user interface;
providing a list of predetermined topic fields in a second element of graphical user interface, said list of topic fields comprising of a plurality of fields of interests; and
displaying, adjacent to the topic fields, a list of corresponding data fields in a third element of graphical user interface, wherein said corresponding data fields comprised of a plurality of selectable subtopics; and
wherein the first element, the second element and the third elements are concurrently displayed as part of the interface.

2. The method according to claim 1, wherein the graphical user interface comprises three segments, including a first segment being an upper segment, a second segment being a left segment, and a third segment being a right segment;
wherein a target topic inquiry is displayed in the first segment;
wherein a list of topic fields is displayed in the second segment;
and wherein a list of corresponding data fields is displayed in the third segment.

3. The method according to claim 1, wherein each said predetermined topic field comprised of one or more subtopic fields capable of being associated with a plurality of selectable subtopics in said corresponding data fields, and said predetermined topic field configuring to organize said subtopic fields in a predetermined format.

4. The method according to claim 3, wherein said predetermined format comprises of a list of fields of interests.

5. The method according to claim 1, wherein said list of predetermined topic fields comprises of independent loading and displaying in the order of said predetermined format.

6. The method according to claim 1, further comprising the steps of:
determining whether the display exhibits a dimension appropriate to said list of predetermined topic fields, and if not; and
displaying the predetermined topic field in sequencing individually.

7. The method according to claim 1, further comprising the steps of:
receiving from a user a selection of a displayed subtopic from the data fields;
referencing said selected subtopic to an updated target topic inquiry; and
updating the target topic inquiry in display.

8. A computer system for displaying a uniformly formatted graphical user interface for selectable contents, said computer system comprising:
a means for receiving and displaying a target topic inquiry;
a means for providing a list of plurality of topic fields of interests; and
a means for displaying a list of corresponding data fields adjacent to said topic fields of interests,
whereby the topic fields and the data fields, in response to said target topic inquiry, display associated selectable contents.

9. The computer system as recited in claim 8, and further comprising:
means for configuring said list of plurality of topic fields of interests in a predetermined format; and
means for associating the topic fields and the data fields in display.

10. The computer system as recited in claim 8, wherein:
said loading and displaying means comprises of a predetermined format.

11. The computer system as recited in claim 8, and further comprising:
means for determining the dimension of display; and
means, responsive to said dimension of display, for displaying in sequence individually for said list of plurality of topic fields of interests.

12. The computer system as recited in claim 8, and further comprising:
means for receiving user selection of a displayed subtopic of the data field;
means, responsive to said displayed subtopic, for referencing an updated target topic inquiry; and
means for updating the target topic inquiry in display.
